(19) United States
(12) Patent Application Publication
(10) Pub. No.: US 2012/0324889 A1
(43) Pub. Date: Dec. 27, 2012

(54) ADVANCED UNIFLOW RANKINE ENGINE AND METHODS OF USE THEREOF

(75) Inventors: William L. PETITJEAN, Fall City, WA (US); John M. ROSE, Seattle, WA (US)

(73) Assignee: MicroSteam, Inc. dba Practical steam, Seattle, WA (US)

(21) Appl. No.: 13/528,349

(22) Filed: Jun. 20, 2012

Related U.S. Application Data
(60) Provisional application No. 61/500,753, filed on Jun. 24, 2011.

(51) Int. Cl. F01K 7/36; A01G 23/08; F01K 13/00; B23P 6/00

(52) U.S. Cl. 60/645; 29/888.011; 144/336; 91/418

(57) ABSTRACT

An Advanced Uniflow Rankine Engine (“AURE”) that is effective and thermodynamically efficient at higher speeds (e.g., 400-1800 rpm) and has low torque output. This allows the AURE to be compact of size without the need for a massive foundation found in prior art steam engines. The AURE includes an admission valve assembly, a cylinder head/valve gear assembly, a cylinder/piston assembly, a crank shaft assembly, an external sump, and an integral condenser. The admission valve assembly includes a counterbalancing poppet valve and valve stem that creates counterbalanced unsupported areas that allow the poppet valve to operate at higher speeds. The AURE can be fueled by raw, unprocessed fuel, including biomass, to generate efficient energy in a smaller overall package.

### RELATED APPLICATION

The present non-provisional application claims priority to U.S. Provisional Patent Application No. 61/500,753, filed on Jun. 24, 2011, and entitled “Advanced Uniflow Rankine Engine and Methods of Use Thereof.”

### TECHNICAL FIELD

The present invention relates to an improved output uniflow Rankine steam engine that can operate at high speeds (above 400 rpm), uses smaller components and does not require a large concrete foundation such that the engine of the present invention can be used in remote locations and can be fueled by biomass. Further, the present invention includes a conversion kit for and a method of converting a Diesel engine to steam operation.

### BACKGROUND OF THE INVENTION

Currently, low grade fuels (low density, low heating value solid, liquid and gaseous substances) are not competitive with higher grade commercial fuels in small scale (e.g., less than 2000 kW) mobile and stationary power plants. This is mainly due to the lack of small scale, efficient, low cost steam prime movers that can economically convert low grade fuels into usable, industrial power.

The traditional reciprocating steam engine, in its various forms, became economically and technologically obsolete circa 1950. The traditional steam engine's place in history is fixed by its boiler's ability to convert raw, unrefined fuel sources into clean, high quality steam energy that was then converted to mechanical work in simple piston type prime movers. The steam engine's obsolescence in the mid 20^{th} century was largely driven by the increasing availability of refined, petroleum based fuels that were better utilized in more efficient heat engine cycles (Otto, Diesel and Brayton cycles) and the development of low cost electrical power delivered by the interconnected utility power grid.

The final evolution of reciprocating steam engine technology circa 1950 is represented by the uniflow steam engine. The first American uniflow engine was built in 1913 by the Skinner Engine Company of Erie, Pa. Skinner built its last uniflow engine in 1982. The Skinner Engine Company closed its doors and was liquidated in 2003.

The Skinner Universal Unaflow steam engine, circa 1950, represents the current state of the art for commercially manufactured, industrial steam engines applied to stationary service. A section view of a Skinner Unaflow 200 is shown in FIG. 1 illustrating an admission valve 202, a cylinder head 204, a cylinder/piston assembly 206, and a crank shaft assembly 208, all supported by a massive concrete foundation 210. The Skinner Unaflow steam engine was a major improvement over previous engine types because it improved steam flow dynamics and thermal efficiency. But it could only work at relatively low speeds (e.g., generally not exceeding 400 rpm). Thus, the Skinner Unaflow engine required high torque outputs. The result is that the Skinner engine had five major weaknesses: (a) massive and costly components that could withstand high reaction forces generated by large piston diameters due to low rotative speeds (generally not above 400 rpm); (b) double acting pistons required complex piston rod/crosshead/connecting rod assemblies that limited rotative speeds due to high inertia forces that could not be adequately balanced at high speed; (c) long cutoffs of up to 40% that adversely impacted thermodynamic performance; (d) need for large concrete foundations to support the heavy engine weights and separate condenser, and, therefore, lack of portability; and (e) higher cost compared to less efficient steam turbines due to higher manufacturing and labor costs.

A compact thermodynamically and power efficient steam engine that runs at higher speeds, and therefore, requires lower torque outputs, has smaller components and does not require a massive support foundation is currently unknown in the prior art.

### SUMMARY OF THE INVENTION

The present invention is directed to an Advanced Uniflow Rankine Engine (“AURE”) that can run at higher speeds (e.g., above 400 rpm and up to 1800 rpm) and, thus, requires lower torque outputs. This lower torque output, in turn, allows the power delivery through smaller components that do not need to be supported by a massive concrete foundation as does the prior art uniflow engine. The fact that the AURE can be made compactly and relatively portable makes it ideal for off-grid power generation applications. It can be fueled by biomass, such as slash and thinnings as part of forest management practices, or for providing steam-generated power at a merchantable timber source to add value to wood product processes.

The AURE includes a cylinder head assembly, an admission valve assembly, a cylinder/piston assembly, a crank shaft assembly, a valve gear assembly, an external sump, and an integral condenser. The admission valve assembly includes a poppet valve and a valve stem that provide counterbalancing by creating counterbalanced unsupported areas that reduces the amount of force required to open a poppet valve by the valve gear assembly. The poppet valve may be a large single seat type that provides maximum steam port opening and quick action.

According to one aspect of the invention, the admission valve assembly creates double counterbalancing of the admission valve with the poppet valve being double balanced. According to another feature of the invention, the counterbalancing may include a counterbalance plunger installed within a hollow interior of the valve stem. The valve stem may further include double labyrinth concentric grooves to provide a frictionless seal against live steam and allows a higher speed of operation of the poppet valve without outside lubrication.

The cylinder/piston assembly may include a trunk style piston of relatively small bore and short stroke to operate at higher speeds.

In another form of the invention, the condenser is a high vacuum condenser.

The combined AURE engine and integral condenser may include sections for vapor and liquid and further allows for an overall compact size.

When the AURE is placed into a conventional Rankine cycle with an evaporator (boiler), condenser, and pumps, the overall energy generation plant can produce mechanical work using raw, unrefined fuel sources such as biomass (e.g., residual forest waste). The overall AURE steam-powered generator, however, is much more compact in size than the prior art. It can be transported to remote areas, particularly where remotely-accessed biomass may be located. This cuts down on the high cost and pollution from using conventional fuel sources (e.g., Diesel oil) to transport the biomass to the AURE generator. This compact-size steam generator using the AURE engine can be utilized within deep forests as part of forestry management or at a merchantable timber source to allow value-added processing at or closer to the power source (such as at sawmills, or wood palletizing and pulp chipping). Further, the AURE can be used to produce higher value wood processed products closer to the power source, thereby reducing transportation logistics, costs and additional carbon emissions from such transportation.

The AURE's single acting, simple expansion design lends itself to conversion of a two stroke uniflow Diesel engine to steam operation. The conversion process replaces a cylinder head of the Diesel engine with a steam jacketed, poppet valve steam cylinder head. Further, a roots blower, as part of the Diesel engine system, is replaced with a high vacuum condenser. The resulting converted Diesel to steam engine operates at high volumetric efficiency.

The AURE may also be part of an overall solution for off-grid power generation, particularly in remote areas, and can be fueled by raw, unfiltered biomass.

These and other advantages will become more apparent upon review of the Drawings, the Detailed Description of the Invention, and the Claims.

### BRIEF DESCRIPTION OF THE DRAWINGS

Like reference numerals are used to designate like parts throughout the several views of the drawings, wherein:

FIG. 1 is a section view of a Prior Art uniflow engine design, including an admission valve, a cylinder head, a cylinder/piston assembly, and a crank shaft assembly, all supported by a massive foundation;

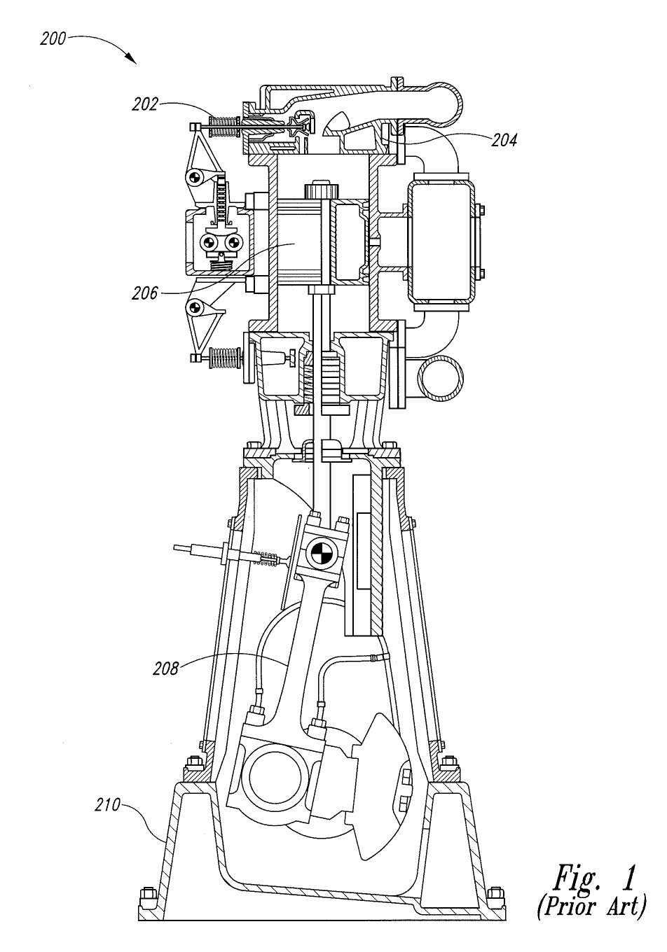

FIG. 2 is a section view of the Advanced Uniflow Rankine Engine (“AURE”) of the present invention illustrating a cylinder head assembly, an admission valve assembly, a cylinder/piston assembly, a valve gear assembly, a crank shaft assembly, an external sump, and an integral condenser; FIG. 2 also schematically illustrates other conventional components of the Rankine cycle including a receiver/separator, boiler, radiator, pumps and accessories;

FIG. 3 is a section view of the AURE cylinder head assembly having a cylinder head, a clamp plate, and a valve head and guide;

FIG. 4 is a section view of the AURE admission valve assembly illustrating a poppet valve and a valve stem, an insert valve seat, a valve spring, a spring retainer assembly, and a counterbalance plunger assembly and schematically illustrating the double counterbalancing effect of steam pressure between the poppet valve, the valve stem, and created unsupported areas (A, B, C, D) that reduces the amount of force required to open a poppet valve by the valve gear assembly;

FIG. 5 is a section view of the AURE valve gear;

FIG. 6 is a schematic view of a conversion of a two stroke uniflow Diesel engine to a steam engine; and

FIG. 7 is a schematic view of the AURE engine of the present invention as may be used in a forestry management application as well as in value-added wood processing applications.

### DETAILED DESCRIPTION OF THE INVENTION

The present invention is directed to an Advanced Uniflow Rankine Engine (“AURE”) described in detail below and represents a methodical, systematic combination of unique mechanical and process improvements with traditional uniflow engine configurations. The present invention includes all engine configurations of one through 20 cylinders, inline or V type, with outputs equal to or less than 2000 kilowatts (2692 horsepower). As discussed further below, the AURE may be utilized in conjunction with other conventional Rankine cycle components, including a boiler, steam inlet manifold, a receiver/separator, radiator, and various pumps and accessories that are included in the larger scope of the invention for various applications.

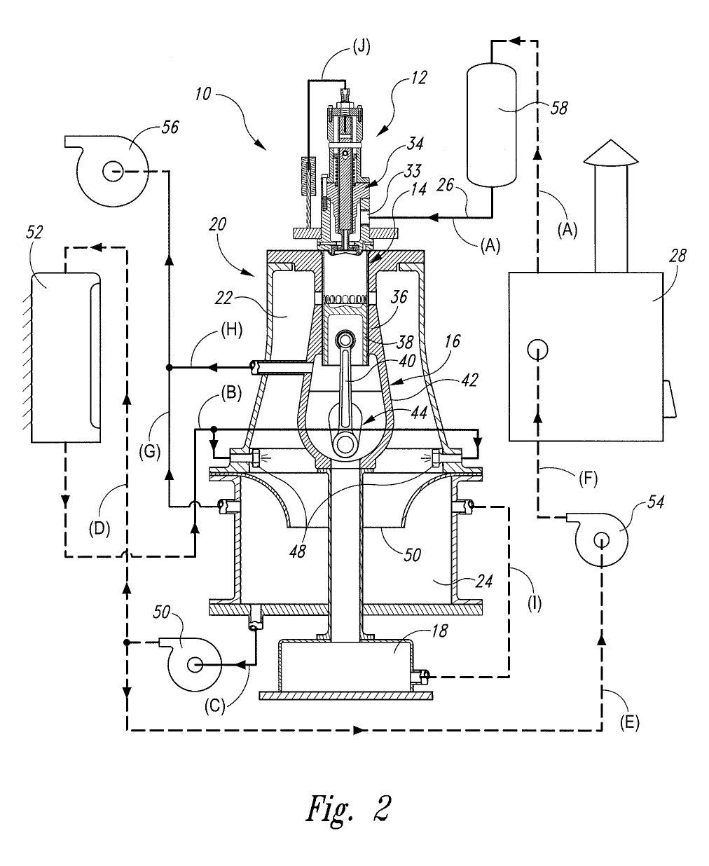

Referring to FIG. 2, the AURE 10 is illustrated as a single acting, single expansion, vertical piston type steam engine. The major elements of the AURE 10 are the 1) a Cylinder Head/Valve Gear assembly 12, 2) a Cylinder/Piston assembly 14, 3) a Crank shaft assembly 16, 4) an External sump 18, and 5) an integral condenser 20 having a vapor section 22 and a liquid section 24. These components are identified in greater detail below.

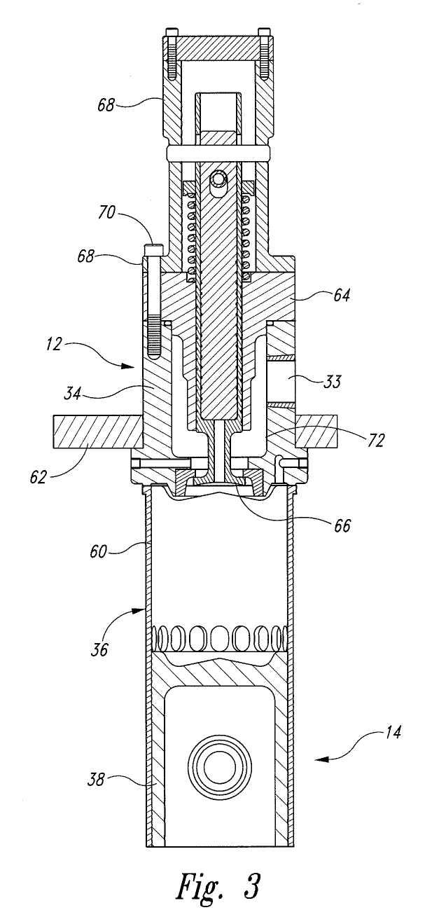

Referring also to FIGS. 3-5, Cylinder Head/Valve Gear assembly 12 receives live steam 26 from a boiler 28 that are schematically illustrated in FIG. 2. An admission valve 30 and valve gear 32 admit steam from an inlet 33 into the hollow cylinder head 34 and to an associated cylinder 36 at the appropriate times to act on a piston 38. The Cylinder/Piston assembly 14 consisting of the cylinder 36, piston 38, and a connecting rod (not illustrated but generally known) contains the admitted steam so it works against the piston 38, which, in turn, works through the connecting rod to turn a crank shaft 40 of the Crank shaft assembly 16. The steam pressure acting against the piston 38 and the resulting rotation of the crank shaft 40 is the primary mechanism that converts heat energy into mechanical work. The cylinder 36 contains ports (also not illustrated) to condenser 20 near the bottom of the piston's stroke. The piston 38 functions as an exhaust valve by allowing expanded steam, at the end of the power stroke, to exhaust into the vapor section 22 of the condenser 20.

The Crank shaft assembly 16 houses the cylinder 36, piston 38, connecting rod (again not illustrated), crank shaft 40, and crankcase 42. This arrangement may be a typical slider crank mechanism that converts the linear motion of the piston into rotary motion at an output end 44 of the crankshaft 40. Crankcase 44 may be separated and sealed from the condenser's vapor and liquid sections 22, 24 because the lubricant (e.g., lubricating oil) that would be used by the moving parts is normally incompatible with the exhaust steam in the condenser sections.

External sump 18 contains engine lubricant (e.g., lubricating oil) in sufficient quantities to cool the lubricant and provide a surge tank for an engine pump (also not illustrated).

Crankcase 42 is surrounded by the integral condenser sections 22, 24, while the “External sump” 18 may be positioned outside the condenser 20 for easier access and improved cooling of the surface area. The vapor section of the condenser 20 surrounds the crankcase and receives exhaust steam from the cylinder via cylinder exhaust ports (not illustrated).

The vapor section 22 of condenser 20 is attached to the liquid section 24. A bank of cooling water spray nozzles (schematically represented at numeral “46”) may be included into the bottom of the vapor section 22. The resulting cooling water spray condenses the exhaust steam into liquid and drops (liquid condensate) through a schematically represented condenser cone 48 that is held between the two condenser sections 22, 24 into the liquid section 24. A condensate/cooling water pump 50 may deliver cooling water fraction to a radiator 52 and condensate fraction (back) to a boiler feed pump 54. Non-condensable gases are evacuated from an upper liquid section annulus around the outside of the condenser cone 48 by a vacuum pump 56. Vacuum pump 56 also evacuates the crankcase 42 to maintain pressure equilibrium between the crankcase 42 and the condenser sections 22, 24.

Boiler feed pump 54 returns condensate to boiler 28 where it is evaporated to high pressure steam. The boiler steam is fed to inlet 33 of engine cylinder head 34 via a receiver/separator 58. Receiver/separator 58 removes condensate from the steam lines prior to entry into the cylinder head 34.

The AURE operates on the familiar Rankine cycle that consists of an evaporator (boiler 28), expander (engine or AURE 10), condenser 20, and pump (boiler feed pump 54). The basic working fluid state and flow pattern is also schematically illustrated in FIG. 2. Live boiler steam at (A) flows from the boiler, through the receiver/separator and into the cylinder head where it is admitted to the cylinder. The steam expands against the piston until it uncovers the exhaust ports in the cylinder. The expanded steam exhausts to the condenser vapor section through the exhaust ports where it passes through the cooling water sprays supplied by the cooling water lines (B). The exhaust steam condenses to liquid condensate, falls to the bottom of the condenser liquid section and creates a vacuum in the condenser. The condensate and cooling water are evacuated from the condenser by the condensate/cooling water pump (C). The cooling water fraction is delivered to the radiator at (D) to remove rejected heat and the condensate fraction is delivered to the boiler feed pump inlet at (E). The boiler feed pump delivers condensate back to the boiler at its working pressure at (F). Non-condensable gases are evacuated from the condenser liquid section at (G) by the vacuum pump. The crankcase is evacuated by the vacuum pump at (H) to maintain pressure equilibrium between the crank case and the condenser sections. The external oil sump is connected to the top end of the condenser liquid section via the water trap line (I). This line completes the water trap circuit. The hydraulic actuator line (J) connects the master plunger/barrel and valve actuator to complete the hydraulic valve gear circuit.

Referring again to FIG. 3, the Cylinder Head/Valve Gear assembly 12 consists of a cylinder head 34 that closes the top of the cylinder 36 and holds a cylinder liner 60 in place. Cylinder head 34 is connected to the engine (via the engine block at the block head surface) and may be held in place by a clamp plate 62 or other fastening means. A “valve head and guide” 64 closes the top of the cylinder head 34 and provides a self sealing guide for a poppet valve 66. The cylinder head may further include a riser spool 68 that sits on top of the “valve head and guide” 68 and head bolts 70 that bolt through the riser spool 68 and valve head and guide 64 into the cylinder head 34 to tie the basic assembly together so it is steam tight. In the version illustrated in FIG. 3, there are four head bolts but the number will depend on the ultimate number of cylinders.

The cylinder head 34 is preferably bored hollow, closed on the bottom and open on the top. The arrangement of elements in the basic assembly (cylinder head, valve head and guide and riser spool) creates a closed annular volume 72 in the hollow cylinder head 34 that is filled with live steam from the boiler. Annular volume 72 is connected to the boiler 28 via steam inlet 33 through a suitable steam manifold (not illustrated, but well known in the industry), the receiver/separator 58 and steam piping (not illustrated, but also well known in the industry). The cylinder head assembly is designed as an independent unit on multi-cylinder engines to eliminate thermal growth stresses common with mono-block cylinder head construction.

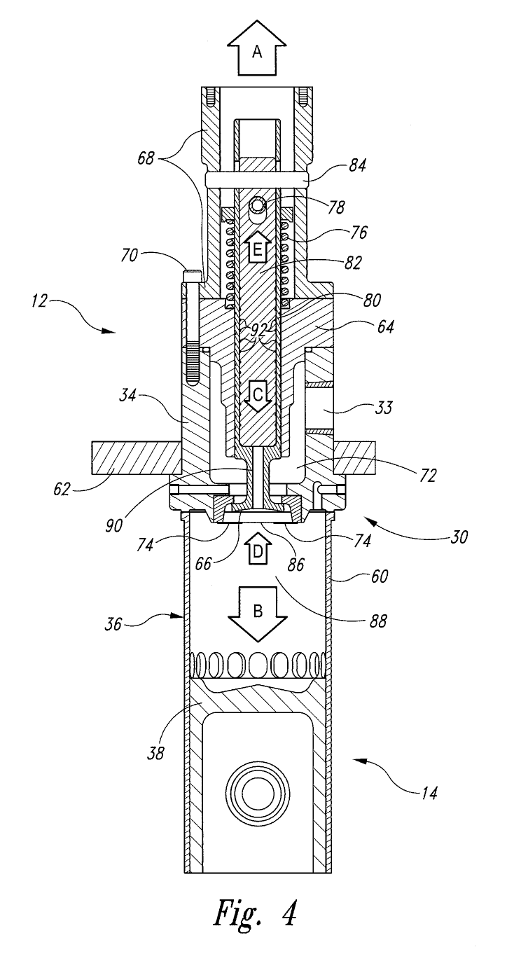

The admission valve assembly is more fully illustrated in FIG. 4 and schematically illustrates the counterbalancing motion of the admission valve's poppet valve 66. This admission valve consists of the poppet valve 66, an insert valve seat 74, a valve spring assembly having a valve spring 76 and a retainer pin 78, a valve stem 80 and optional counterbalance plunger 82 and plunger pin 84. Poppet valve 66 moves axially along the center line of the cylinder head 34 with a maximum stroke of approximately 0.285″. Valve spring 76 holds the admission valve normally closed against the insert valve seat 74 with sufficient contact stress to prevent live steam from entering the cylinder 36 from the closed annular volume 72 in the cylinder head 34. When valve gear 32 moves the admission valve 30 to the right (down), it lifts off the insert valve seat 74 and allows live steam to flow from the cylinder head annular volume 72 into the cylinder 36 where it acts against the 38 piston and further described below. The valve gear 32 times the action of the admission valve 30 so it admits steam to the cylinder 36 only during the proper positioning of the piston 38 during its power stroke.

The admission valve 30 is balanced to allow the poppet valve 66 to operate at higher speeds without excessive force on the valve gear 32. Admission valve balancing is based on opposing steam forces acting through unsupported areas. The unsupported areas are defined by the areas of the valve port 86 into the cylinder 36, the area of the valve stem 80 (outside diameter or O.D.) going through the “valve head and guide” 64 and the area of the valve stem 80 (inside diameter or I.D.) surrounding the counterbalance plunger 82. The valve port area 88 is the primary area and the O.D. and I.D. areas are the counterbalancing areas acting to reduce the effect of the primary area force at various points in a complete cycle (one revolution).

Balancing is intended to reduce valve gear forces required to open and close the valve while maintaining sufficient contact stress at the valve seat to ensure steam tight closure of the valve. Balancing is not intended to counteract inertia forces created by valve motion accelerations. The unsupported areas (A, B, C and D) that create the required steam forces are illustrated in FIG. 4. Unsupported areas A and B comprise the primary counterbalance. Unsupported areas C and D comprise the secondary counterbalance. Thus the poppet valve 66 and valve stem 80 are double counterbalanced to reduce all steam forces tending to open or close the valve. The mechanical spring force (E) is also illustrated. The individual magnitudes, net magnitudes and directions of these forces are tabulated in Table 1 below. The table shows that the benefit obtained by double counterbalancing reduces the required valve gear opening force to less than half the force required if there is no counterbalancing.

TABLE 1

| | | | b | | |
|---|---|---|---|---|---|
| | | | resul- | c | d |
| | | a | tant | net | force |
| | | area | force, | force, | direction |
| Item | description | in² | lbs | lbs | up/down |
| | PRIMARY BALANCING | | | | |
| | 200 psi head pressure | | | | |
| 1 | UNSUPPORTED AREA A | 1.537 | 307.40 | | UP |
| 2 | UNSUPPORTED AREA B | 1.591 | 318.20 | | DOWN |
| 3 | NET UNSUPPORTED | 0.054 | | 10.80 | DOWN |
| | AREA | | | | |
| | SECONDARY | | | | |
| | BALANCING | | | | |
| | 200 psi cylinder pressure | | | | |
| 4 | UNSUPPORTED AREA C | 1.031 | 206.11 | | DOWN |
| 5 | UNSUPPORTED AREA D | 1.514 | 302.80 | | UP |
| 6 | NET UNSUPPORTED | 0.483 | | 96.60 | UP |
| | AREA | | | | |
| | SECONDARY | | | | |
| | BALANCING | | | | |
| 7 | 0 psi cylinder pressure | | | 0.00 | |
| 8 | MECHANICAL SPRING | | | 91.00 | UP |
| | FORCE E | | | | |
| 9 | Spring force required if no | | | 398.40 | UP |
| | counterbalance steam forces | | | | |
| | (valve opening force | | | | |
| | required from valve gear) | | | | |
| 10 | Valve opening force | | | 187.60 | DOWN |
| | required with primary | | | | |
| | and secondary | | | | |
| | counterbalance forces | | | | |

The primary counterbalancing principle is based on the unsupported area A being only slightly smaller than unsupported area B. Unsupported area A is formed by the unusually large diameter valve stem 80 extending through the “valve head and guide” 64. The valve stem 80 seals live steam in the annular volume 72 of cylinder head 34 and prevents steam leakage to the atmosphere outside the “valve head and guide” 64. Unsupported area B is formed by the valve (e.g., the head of the poppet valve 66) that closes the valve port between the annular volume 72 of cylinder head 34 and the cylinder 36. When the valve is closed it prevents steam leakage from the cylinder head annular volume 72 into the cylinder 36. Therefore, the live steam pressure (boiler pressure) in the cylinder head annular volume 72 acts in opposing directions against the valve stem 80 covering unsupported area A and the valve covering unsupported area B. The net effect of steam pressure acting on unsupported areas A and B is to nearly cancel each other due to the opposing directions of their steam derived axial forces. The “valve stem and valve” 64 is integral with the poppet valve and valve stem and does not move independently. Therefore, the resulting net force (shown in Table 1) is only 10.8 lbs (3c) acting to open the valve (down force). As the valve stem diameter is reduced unsupported area A becomes smaller. As unsupported area A approaches zero square inches the resulting net force (shown in Table 1) approaches 318.2 lbs (2b) acting to open the valve (down force). The higher resulting net force would normally require an extra heavy valve spring to ensure steam tight closure of the valve at the above steam pressure conditions.

A secondary counterbalancing principle may be utilized to offset the variable pressure in the cylinder 36. Cylinder pressure can vary from boiler pressure to exhaust pressure. This variable pressure acts in the up direction against unsupported area B and offsets the steam pressure in the cylinder annular volume that acts down against unsupported area B. As the cylinder pressure approaches boiler pressure the net pressure acting on both sides of unsupported area B approaches 0 psi and the net effect of the pressure acting up on unsupported area A adds to spring force E. This additive, composite force acts to hold the valve closed and would require in excess of 400 lbs of force from the valve gear to open the valve. Elimination of this excessive composite force is accomplished with the counterbalance plunger installed in the hollow interior of the valve stem. The counterbalance plunger 82 is stationary because it is pinned to the riser spool 68 and it is sealed against leakage to the atmosphere. The hollow interior of the valve stem 80 is connected to the cylinder 36 by a counterbalance port 90. Thus, the pressure in the cylinder that is acting against unsupported area D (the back side of unsupported area B) also acts against the stationary counterbalance plunger at unsupported area C. Unsupported area C is slightly smaller than unsupported area D. Therefore, the net force is the difference between force D and force C. The table shows this net force equals 96.6 lbs, which reduces the composite force holding the valve closed to 187.6 lbs. This reduces the maximum valve opening force to less than half the uncompensated composite force and justifies the addition of the secondary balance to the valve geometry.

The admission valve stem 80 may employ double labyrinth packing. This can be effectuated through the use one of the well known water-groove type wherein concentric grooves 92 on the admission valve stem 80 outside diameter and the counterbalance plunger 82 outside diameter are properly spaced and of sufficient quantity to seal steam from leaking past the admission valve stem 80 from the cylinder head annular volume and cylinder to the atmosphere. The grooves 92 fill with water (condensed steam), form a frictionless seal against live steam pressure and allow high speed operation of the poppet valve 66 without outside lubrication. The admission valve stem moves to open and close the poppet valve relative to the valve head and guide and the counterbalance plunger. Therefore, the labyrinth packing must seal both the outside diameter and inside diameter of the hollow admission valve stem against steam leakage. This constitutes a unique and novel application of the labyrinth seal prior art as a double labyrinth seal operating on the inside and outside surfaces of one hollow valve stem.

The admission valve assembly and poppet valve may have other novel applications apart from the AURE engine.

The cylinder and running gear configuration is the well known slider crank type consisting of a ported cylinder liner 60 (utilized by uniflow diesel and steam engines) that provides a sealed cylinder 36 and running surface for a trunk type piston 38 (crosshead/piston) acting on a crank shaft via a connecting rod. The cylinder liner 66 is made of a suitable material to withstand the dynamic and static forces generated by the engine and is finished to create a low friction running surface for the piston. The exhaust ports (not illustrated) in the cylinder liner are sized and located to allow expanded steam to exhaust from the cylinder to the condenser when the piston uncovers the exhaust ports during approximately the last 10% of the piston's power stroke and the first 10% of the return (compression) stroke. The cylinder ports are symmetrical and encircle the circumference of the cylinder liner. The cylinder liner described above is typical of the cylinder liners used by two-stroke, uniflow diesel engines.

The single acting, simple expansion uniflow configuration of the AURE may be accomplished via a trunk-type piston, such as the well known single acting type that functions as a crosshead to react against lateral forces created when the linear motion of the piston is converted to rotary motion at the crankshaft centerline. It is closed on top to absorb the steam pressure forces acting against it. It is open on the bottom to accept a connecting rod that may be pinned to the piston via a wrist pin that is arranged with a bearing so the connecting rod can oscillate through its arc of motion developed by the crank shaft/crank circle. The piston is made of a suitable material to remain dimensionally stable, withstand the steam forces acting against it and to create a low friction running surface that is compatible with the cylinder liner running surface. The upper end of the piston outside diameter contains the proper number of pressure breaker piston rings to seal against the prevailing steam pressure. The lower end of the piston skirt contains the proper number of combination pressure breaker/oil containment piston rings to seal the exhaust ports from the crankcase when the piston is at top dead center and to prevent engine oil in the crankcase from leaking into the exhaust ports and the condenser. The piston ring arrangement described above is similar to the typical piston ring arrangement in two stroke uniflow diesel engines. According to one aspect of the present invention, the trunk type piston has a relatively small bore (e.g., 4.25″) and a short stroke (e.g., 5″) that work well at higher speeds.

The connecting rod converts the linear motion of the piston to the rotary motion of the crank shaft. It is made of a suitable material to withstand the axial loads and resist buckling while transmitting working, transient and shock loads to the crank shaft. It is equipped with properly sized bearings to allow free movement during operation. The connecting rod is drilled and arranged for full pressure lubrication of the bearings with engine oil. The engine oil is supplied through the crank end bearing. The connecting rod arrangement described above is similar to the connecting rods used in all piston type reciprocating engines.

In use, the crank shaft delivers the rotary motion imparted by the connecting rod to the output end of the crank shaft. It is held in place by at least two main bearings that limit its motion to rotary motion only. It is made of a suitable material to resist the lateral and torsional forces acting on it during operation. It is drilled and arranged for full pressure lubrication of the main bearings and crank bearing with engine oil. The engine oil would normally be supplied through main bearing ports (not illustrated). The crank shaft arrangement described above is similar to the crank shafts used in all piston type reciprocating engines.

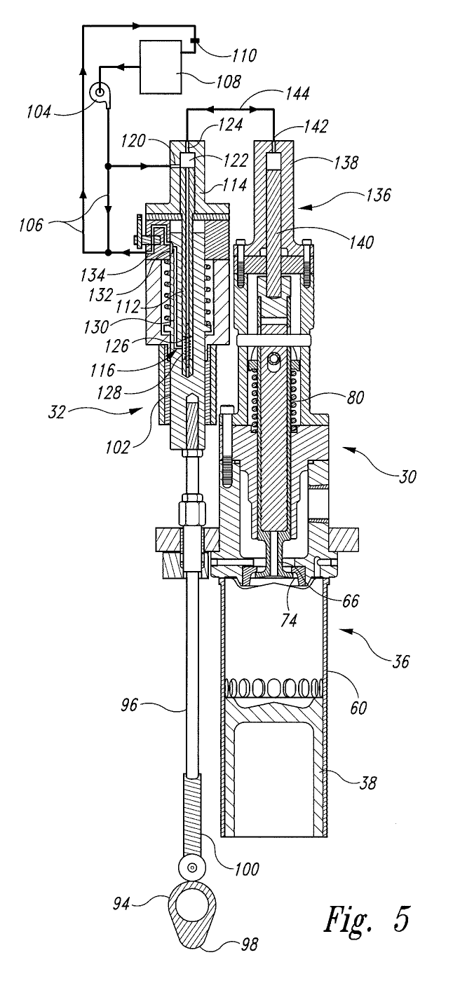

Referring to FIG. 5, the valve gear assembly is a mechanical/hydraulic drive train. It provides the motive force to actuate the poppet valve timing to open and close the poppet valve to admit live boiler steam to the cylinder from the cylinder head annular volume between the proper points of piston travel and regulates engine speed and/or power output by varying the point of admission cutoff. The point of cutoff increases or decreases the expansion ratio during the piston's power stroke. Changing the expansion ratio raises or lowers cylinder mean effective pressure (MEP). MEP is a primary determinant of engine power output at a fixed or variable speed. Cutoff governor control of engine speed and/or power output is a well known governing methodology for both fuel injected diesel engines and reciprocating steam engines of all types. The AURE application below is a unique and novel application of the familiar cutoff governor configuration because it utilizes a hydraulic system to actuate the poppet valve and control the valve cutoff via a variable stroke hydraulic lifter. The valve gear assembly and its operation are described in detail below.

A camshaft 94 and push rod 96 provide the primary motive force to operate the poppet valve 66. The camshaft 94 rotates and is driven by a gear train, gear belt, or roller chain (none illustrated) that takes power from the crank shaft. The base timing of the poppet valve's opening and closing is determined by the relative position of a cam lobe 98 on the camshaft 94 and the position of the piston 38. This timing relationship is mechanically fixed and is not normally altered in service. The push rod 96 rides on a roller cam follower 100 that transmits the cam lobe's rotary motion into vertical linear motion which, in turn is transmitted to a variable stroke hydraulic lifter 102. The push rod input motion to the variable stroke hydraulic lifter has a constant amplitude determined by the height and profile of the cam lobe. The roller cam follower 100 and the push rod 96 operate in guide bearings (not illustrated) that react against lateral forces when converting camshaft rotary motion into vertical linear motion. The camshaft operates in a series of bearings to maintain camshaft position relative to the roller cam followers. The camshaft and roller cam follower are pressure lubricated by the engine oil system. The push rod bearings are self lubricating and require no external lubrication source.

A hydraulic pump 104, hydraulic rail 106 and hydraulic reservoir 108 (all schematically represented) comprise the support system that supplies hydraulic motive force to operate the hydraulic portion of the valve gear. The hydraulic pump forces hydraulic oil from a hydraulic reservoir through a hydraulic rail. The hydraulic rail is a circulating oil line that circulates hydraulic oil from the reservoir back into the reservoir. An orifice 110 restricts the hydraulic rail return line to the reservoir so the entire rail operates at an elevated, but relatively low pressure between the pump discharge and the orifice. The hydraulic pump can be operated by the engine or some external means.

The variable stroke hydraulic lifter 102, a plunger 112, and barrel 114 are the moving components that, acting together, provide hydraulic pressure to actuate the poppet valve 66 and modulation of the push rod stroke to govern poppet valve cutoff. The hydraulic lifter 102 is connected to the push rod 96 and replicates the push rod stroke and timing. A lower end 116 of the plunger 112 is inserted into the hydraulic lifter 102 and is free to move or remain stationary relative to the hydraulic lifter's movement. An upper end 118 of the plunger 102 is inserted into barrel 114. Barrel 114 is fixed and is stationary relative to the hydraulic lifter 102. Any motion imparted to the plunger by the hydraulic lifter causes the plunger to move upward from its shouldered resting position in the barrel as shown. When the plunger is at rest, a charge port 120 charges a barrel cylinder 122 to hydraulic rail pressure. As the plunger 112 moves upward it closes off the charge port 120, traps hydraulic oil at rail pressure in the barrel cylinder and pushes oil out a discharge port 124. The hydraulic lifter imparts a variable stroke to the plunger relative to its fixed stroke. Hydraulic oil at rail pressure feeds through the hollow plunger, past a reverse flow check 126 to fill a lifter chamber 128, a chamber bleed 130, a chamber bleed port 132, and a regulator bleed port 134. When the regulator bleed port 134 is closed, the hydraulic oil in the lifter chamber 128 is trapped. Since the trapped oil is incompressible the hydraulic lifter and the plunger move together through the hydraulic lifter's entire fixed stroke. When the regulator bleed port 134 is open the hydraulic lifter 102 moves through its fixed stroke, but the plunger 112 remains stationary as the hydraulic oil in the lifter chamber 128 is forced out the regulator bleed port 134 back into the hydraulic rail's return line. The bleed regulator position is infinitely variable between fully open and fully closed. Its position is controlled by the engine governor. Therefore, the lift and cutoff of the poppet valve is controlled by the bleed regulator position. As the bleed regulator is rotated from fully closed to fully open the poppet valve lift is reduced proportionately. Cutoff occurs earlier and earlier until all the hydraulic oil in the lifter chamber is bled off when the bleed regulator is fully open and the poppet valve does not lift from its seat at all. The above described variable stroke hydraulic lifter, plunger and barrel are a unique variation of the well known helix cutoff plunger barrel used with unit Diesel engine fuel injectors. The variable stroke hydraulic lifter, plunger and barrel are specifically adapted for steam engine admission valve use. The various parts of the variable stroke hydraulic lifter are made from materials and finished to be suitable for hydraulic valve service.

A valve actuator assembly 136 may transmit hydraulic pressure from a valve gear discharge port 124 to the poppet valve 66 via the valve stem 80. The hydraulic pressure overcomes the valve spring force and lifts the poppet valve 66 off its insert valve seat 74. The valve actuator assembly 136 consists of an actuator barrel 138, an actuator plunger 140 and an inlet port 142. A coupler (schematically represented as numeral “144”) transmits hydraulic pressure from the valve gear barrel's discharge port 124 to the actuator barrel's inlet port 142. The hydraulic pressure displaces the actuator plunger 140 until the volume swept by it is the same as the swept volume developed by the valve gear plunger during the up stroke of the hydraulic lifter 102. The actuator plunger 140 and valve gear plunger 112 reverse their direction back to their respective rest positions during the hydraulic lifter's down stroke. The various parts of the valve actuator assembly 136 are made from materials and finished to be suitable for hydraulic valve service.

The engine block, crankcase and condenser are preferably combined in an integrated assembly that forms the engine foundation shown schematically in FIG. 2. The assembly contains all the functions associated with conversion of heat to work (rotation of the crank shaft) and condensing exhaust steam to condensate in a high vacuum condenser. The engine block and crankcase are well known and are well represented in the prior art for internal combustion engines. The single acting, single expansion features are less well known in reciprocating steam engines, but are still part of the steam engine prior art. The integration of a high vacuum condenser with a single acting uniflow steam engine block and crankcase is a unique, novel development and is not represented in the prior art.

The engine block is a box section that includes the crank shaft assembly and the vapor section of the condenser. The crankcase is sealed from the condenser vapor section to maintain separation between the engine oil in the crankcase and exhaust steam in the condenser vapor section. The vapor section receives exhaust steam from the cylinder exhaust ports and acts as a high volume, low velocity plenum to maintain condenser vacuum as close to the cylinder exhaust ports as possible. The engine block forms the base that contains and locates the cylinder liner relative to the crank shaft. The crankcase is bolted to the engine block. The engine block also forms the head surface where the cylinder head and valve gear are mounted. The cylinder head closes the top of the cylinder liner. The engine block may be an iron casting or a fabricated steel weldment. It is well represented in the prior art for uniflow diesel engines. However, the engine block and its integral condenser vapor section are unique and novel when applied to reciprocating uniflow steam engines.

The crankcase contains the crank shaft, its supporting bearings, and the cam shaft for the valve gear operation. A vertical standpipe connects the bottom of the crankcase to the External sump 18. The vertical standpipe is sealed from the condenser liquid section so cooling water and exhaust condensate do not mix with engine oil. The combined engine block and crankcase form the basic structural foundation for the engine and support the operation of the piston, connecting rod, crank shaft and the valve gear cam shaft. The crankcase is well represented in the prior art for gasoline, diesel and steam engines. However, the location of the crankcase within the condenser vapor section is unique and novel for steam engines.

An integral condenser is the familiar high vacuum, low level jet type that injects the cooling water into direct contact with the exhaust steam via a cooling water spray nozzle bank. The condenser vapor section rests on top of and is bolted to the liquid section of the condenser. The bottom of the condenser vapor section contains the cooling water spray nozzle bank. The cooling water spray condenses the exhaust steam into liquid condensate. A condensing cone may be sandwiched between the two condenser sections 22, 24. It directs the cooling water and condensate into the center of the liquid section where it falls to the bottom by gravity. The condensing cone prevents exhaust steam from accessing the liquid section and mingling with non-condensable gases which separate from the steam below the cooling water spray nozzle bank. The non-condensable gases collect in the annular space around the outside of the condensing cone where they are evacuated from the condenser 20 by vacuum pump 56. The condensing cone 48 is the primary baffle that prevents the vacuum pump 56 from attempting to evacuate exhaust steam from the condenser 20 while still a vapor. The cooling water and condensate are removed from the bottom of the condenser liquid section by a condensate/cooling water pump 50. The condensate fraction is fed to a boiler feed pump 54 and the cooling water fraction is fed to a radiator 52. Both the condensate and the cooling water are re-used over and over again in a re-circulating system. Both condenser sections are iron castings or welded steel fabrications. The integral, direct contact type jet condenser is well represented in the prior art. However, its application as an integrated part of a uniflow steam engine's foundation and exhaust plenum is unique and novel.

Accessories may be included and are described below because they are unique and novel applications of prior art to the AURE.

A lubrication system is divided into the re-circulating engine oil system for the engine lower end and the dry lubrication of the engine upper end. The engine lower end comprises the crank shaft, connecting rod, piston, camshaft and cam follower. These components, which rotate or reciprocate relative to each other, have their bearings lubricated by a pressurized engine oil system that is typical of internal combustion engines. The upper end consists of the poppet valve, valve stem, valve actuator and valve gear. The valve stem and counterbalance plunger are impregnated with dry lubricant and require no further attention. The valve gear guide bushings are oil impregnated and require no further attention. The internal moving parts of the hydraulic lifter and barrel are lubricated by the hydraulic oil used to operate the poppet valve. The cam follower is lubricated by the engine oil system. The lubrication system is unique and novel for uniflow steam engines because it requires no lubricant injected into the inlet steam in order to lubricate steam wetted parts. The steam wetted portion of the poppet valve and valve stem does not require outside lubrication. The cast iron piston and piston rings receive adequate lubrication from nozzles aimed at the lower cylinder liner and supplied by the pressurized engine oil system. Yet, the cylinder lubrication is prevented from entering the cylinder above the piston by suitably placed oil control rings on the piston skirt.

An oil/water separator may be included in the external oil sump to maintain a minimum water level below the engine oil and engine oil pump intake. Condensed steam inevitably leaks past the piston rings into the crankcase and finds its way to the bottom of the external oil sump. A water trap line to the condenser liquid section outlet may be placed at the proper height on the condenser liquid section to maintain a constant, but relatively low level of water in the bottom of the external oil sump. As leakage enters the sump from above, it sinks through the lighter oil and attempts to raise the water level in the sump bottom. An equal amount of water leaves the trap line into the condenser liquid section. Thus, the water level in the sump is maintained at a constant level and the oil level in the sump is maintained at the proper level independent of water leakage into the sump. The crankcase is evacuated by the same vacuum pump that evacuates the condenser. Therefore, the pressure in the crankcase is equalized with the pressure in the crankcase and the water trap line operates solely on differential density rather than pressure differential. The use of a vertical standpipe and external oil sump allows the engine oil to settle in the sump and properly shed leakage water that finds it way into the sump from the crankcase. The principle of the water trap in the oil sump is well represented in the prior art. However, its application in the vertical standpipe, external oil sump and trap line to the condenser is unique and novel in the AURE.

A steam receiver/separator/manifold location is shown by a receiver/separator 58. The receiver is a tank that approximates 10 times the volume of the cylinder swept volume. Its job is to catch water slugs that occasionally carry over from the boiler and prevent them from slugging the engine with liquid. The receiver outlet is fitted with a dynamic action steam separator that removes entrained moisture from the steam leaving the separator on its way to the engine The steam inlet manifold is a large volume pipe that takes steam from the receiver/separator and feeds one or more cylinders with steam at low velocity to minimize pressure drop into the cylinder head annular volume.

As stated above, advantages of the AURE invention allow an increase of rotative speed from 400 to 1800 rpm to reduce the torque required for a given power output which, in turn eliminates the need for massive components and assemblies. By reducing the torque required for a given output, heavy and complex piston rod/crosshead/connecting rod construction of the prior art is no longer necessary. Lighter, single acting trunk type pistons and connecting rods of the present invention eliminate high, unbalanced inertia forces that prevent high speed operation.

Further, maximum cutoff is reduced from the traditional 40% to something in the range of a desirable 12%. This reduced maximum cutoff significantly improves thermodynamic performance (larger expansion ratio).

Another benefit is that capital cost for manufacture of the AURE is significantly reduced over the known prior art uniflow steam engines due to the compactness of size and smaller sized, uncomplicated components. The compact size and lack of required massive foundation allows the AURE to be relatively portable and can be used in remote locations. Because the AURE size is compact, other Rankine steam engine components, e.g., the boiler, can be commensurately smaller such that the entire steam generator is compact, transportable, and can be adapted for remote, off-grid power generation uses.

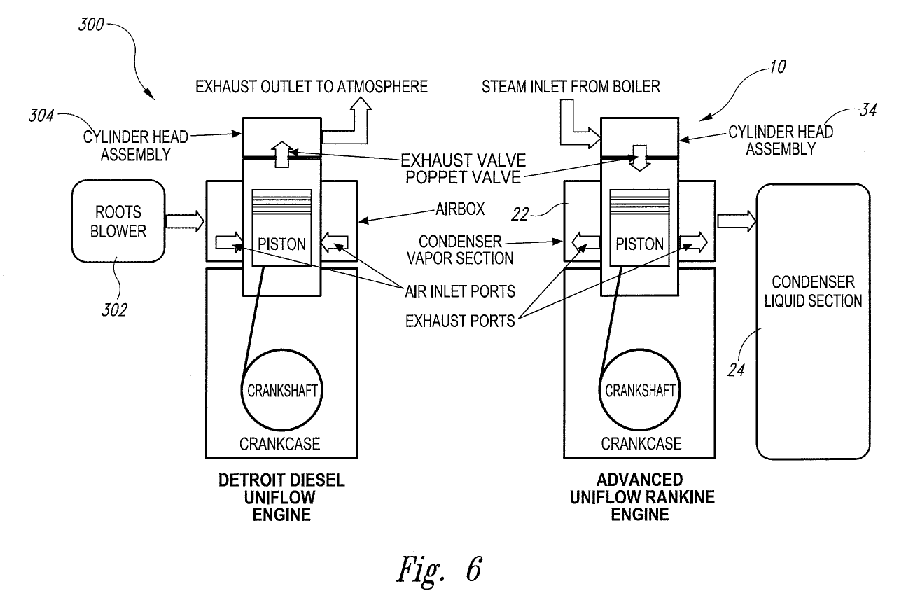

The present invention encompasses converting existing two-stroke uniflow Diesel engines. Uniflow Diesel engines take in air via scavenge ports and exhaust gases exit through an overhead poppet valve. The scavenged air is via forced induction, such as through a mechanical roots blower. Referring to the schematic illustration of FIG. 6, the AURE (with steam jacketed poppet valve steam cylinder head 34 and the forced induction/roots blower is replaced with the AURE high vacuum condenser (liquid condenser 24 and vapor condenser 22) a two-stroke uniflow Diesel engine 300, such as a Detroit Diesel uniflow engine, having root blowers 302, and Diesel fuel cylinder head 304. However, with the AURE, the fuel flow path is reversed. A Diesel engine injector cam is used to drive the AURE poppet valve. In this way the Diesel fuel engine is converted to steam operation.

Moreover, AURE can utilize raw, unrefined fuel sources, such as wood thinnings and high density, dry wood pellets, or other biomass, and efficiently convert the raw, unrefined fuel source into mechanical work. The wood thinnings/dry wood pellets or other biomass might otherwise lack a commercial market due to the high cost of transporting the fuel source to a conventional generation plant. As discussed above, the AURE engine/steam generator is compact in size and may be trailer transported to remote sites where the biomass may be found (e.g., in remote forest lands).

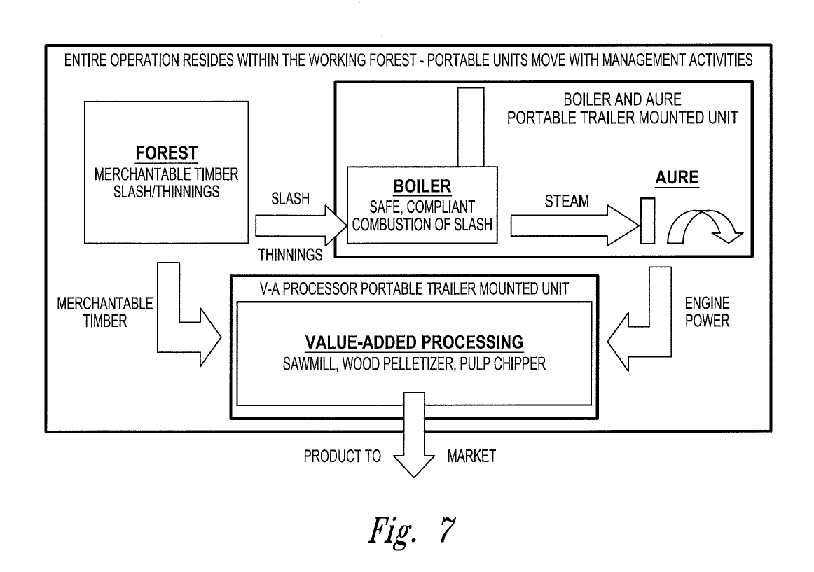

Referring to FIG. 7, the combined AURE powered steam generator can be used in forestry management where forest thinnings and regular slashing of brush and small diameter trees is desirable for healthy forest management. Current practice is through fire management because it is too costly to gather and remove forest thinnings in remote forest areas. But fire management has even greater risk to human and wildlife, as well as to dwellings and other structures. It is desirable to have the ability to utilize forest slash/thinnings/wood pellets at a remote source, instead of through dangerous fire management. Further, and importantly, such a capability creates a commercial market for forest waste/biomass and provides off-grid power to remote locations.

The AURE powered steam generator can also be used at or closer to a merchantable timber source as part of wood processing, such as at a sawmill, wood pelletizer, or pulp chipper, thereby reducing long distance transportation of low-value raw materials. Value added finished products have a high value that withstands long distance transportation better than low value raw materials. Thus, there is an economic and ecological benefit in an overall decrease in transportation requirements (limiting or reducing transportation of raw materials and maintaining transportation for high value finished products).

The illustrated embodiments are only examples of the present invention and, therefore, are non-limitive. It is to be understood that many changes in the particular structure, materials, and features of the invention may be made without departing from the spirit and scope of the invention. Therefore, it is the Applicants' intention that their patent rights not be limited by the particular embodiments illustrated and described herein, but rather by the following claims interpreted according to accepted doctrines of claim interpretation, including the Doctrine of Equivalents and Reversal of Parts.

What is claimed is:

1. An advanced uniflow Rankine engine (“AURE”) comprising:
a cylinder head/valve gear assembly having an inlet to receive live steam;
an admission valve assembly including a counterbalancing poppet valve and a corresponding valve stem;
a cylinder/piston assembly with one end of the cylinder/piston assembly adjacent to the cylinder head/valve gear assembly, said cylinder/piston assembly configured to provide in-line movement between a piston and a corresponding cylinder of the cylinder/piston assembly when live steam pushes on the one end of the cylinder/piston assembly;
a crank shaft assembly having a crank shaft connectedly attached to the opposite end of the cylinder/piston assembly from that adjacent the cylinder head/valve gear assembly, said crank shaft configured to provide a predictable mechanical movement upon in-line movement of the cylinder/piston assembly;
an external sump containing lubricant; such external sump is configured such that the contained lubricant can access the crank shaft assembly and cylinder/piston assembly; and
an integral condenser having a vapor section and a liquid section.

2. The AURE according to claim 1 wherein the poppet valve is a single seat, double pressure balancing poppet valve.

3. The AURE according to claim 1 wherein the valve stem further includes double labyrinth packing.

4. The AURE according to claim 1 wherein the cylinder/piston assembly includes a trunk style piston.

5. The AURE according to claim 1 wherein the piston has a small bore and short stroke.

6. The AURE according to claim 1 wherein the condenser is a high vacuum condenser.

7. A method of providing high speed, low torque output mechanical work, the method comprising:
providing an AURE engine having a cylinder head/valve gear assembly having an inlet; an admission valve assembly that can provide counterbalanced poppet valve action; a cylinder/piston assembly that provides in-line movement between a piston and cylinder; a crank shaft assembly having a crank shaft connectedly attached to the opposite end of the cylinder/piston assembly from that adjacent the cylinder head/valve gear assembly, said crank shaft configured to provide a predictable mechanical movement upon in-line movement of the cylinder/piston assembly, lubrication means, and an integral condenser;
providing a steam input to the AURE; and
operating the AURE at high speed wherein the crank shaft assembly provides low torque mechanical output movement.

8. The method according to claim 7 wherein the AURE operates in the range of 400-1800 rpm.

9. The method according to claim 7 wherein the steam input is a boiler that can be fueled by raw, unfiltered biomass.

10. The method according to claim 9 wherein the biomass fuel is high-density dry wood pellets.

11. An counterbalancing poppet valve assembly comprising:
a single seat poppet valve having a steam port opening;
an insert valve seat; and
a valve spring assembly having a valve spring, a retainer pin, and a valve stem.

12. The poppet valve assembly of claim 10 further comprising a counterbalance plunger and a plunger pin.

13. A method of counterbalancing a poppet valve assembly, the method comprising:
providing a poppet valve assembly having a single seat poppet valve having a steam port opening, an insert valve seat, a valve spring assembly and valve stem where the poppet valve moves relative to the spring biased stem when live steam enters the steam port opening;
feeding live steam into the steam port opening between the poppet valve and the valve stem to create counterbalanced unsupported areas.

14. A compact steam generator comprising:
an AURE steam engine configured to provide mechanical rotation upon being fed live steam; said AURE steam engine consisting of a cylinder head/valve gear assembly to receive live steam, an admission valve assembly including a counterbalancing poppet valve and a corresponding valve stem, a cylinder/piston assembly with one end of the cylinder/piston assembly adjacent to the cylinder head/valve gear assembly, said cylinder/piston assembly configured to provide in-line movement when live steam pushes on the one of the one end of the cylinder/piston assembly, a crank shaft assembly having a crank shaft configured to provide a predictable mechanical movement upon in-line movement of the cylinder/piston assembly, and an integral condenser having a vapor section and a liquid section;
an evaporator configured to create live steam; and
a pipe line to feed the live steam from the evaporator to the admission valve of the AURE steam engine.

15. A method of converting a two stroke uniflow Diesel engine to steam operation wherein the Diesel engine consists of an air inlet port, an airbox that provides pressurized air to a cylinder/piston assembly via the air inlet port, exhaust poppet valve, a cylinder head assembly which forces exhaust gases out of the cylinder/piston assembly exit, a crank shaft assembly, a forced induction blower, and an injector cam that drives the Diesel poppet valve, and operates in one way fuel flow path; the method comprising:
providing an AURE cylinder head/valve gear assembly consisting of a cylinder head/valve gear assembly having an inlet to receive live steam and an admission valve assembly including a counterbalancing poppet valve and a corresponding valve stem and a cylinder/piston assembly with one end of the cylinder/piston assembly adjacent to the cylinder head/valve gear assembly, said cylinder/piston assembly configured to provide in-line movement between a piston and a corresponding cylinder of the cylinder/piston assembly when live steam pushes on the one of the one end of the cylinder/piston assembly;
providing an AURE high vacuum condenser having a having a vapor section and a liquid section;
replacing the Diesel cylinder head assembly, intake valve, and cylinder/piston assembly with the AURE cylinder head/valve gear assembly, admission valve assembly, and cylinder/piston assembly;
replacing the Diesel forced induction blower with the AURE high vacuum condenser;
reversing the Diesel engine fuel flow path; and
using the Diesel injector cam to drive the AURE counterbalancing poppet valve.

16. The method of converting a two stroke Diesel engine according to claim 15 wherein the forced induction blower is a rotary roots blower.

17. The method of converting a two stroke Diesel engine according to claim 16 wherein the airbox is replaced by vapor section of the condenser and the roots blower is replaced by the liquid section of the condenser.

18. A method of forest management, the method comprising:
providing an AURE steam engine configured to provide mechanical rotation upon being fed live steam; said AURE steam engine consisting of a cylinder head/valve gear assembly to receive live steam, an admission valve assembly including a counterbalancing poppet valve and a corresponding valve stem, a cylinder/piston assembly with one end of the cylinder/piston assembly adjacent to the cylinder head/valve gear assembly, said cylinder/piston assembly configured to provide in-line movement when live steam pushes on the one of the one end of the cylinder/piston assembly, a crank shaft assembly having a crank shaft configured to provide a predictable mechanical movement upon in-line movement of the cylinder/piston assembly, and an integral condenser having a vapor section and a liquid section;
providing a boiler means capable of burning raw biomass to create steam and feed it to the AURE engine;
transporting said AURE steam engine and boiler means to a forested area;
identifying undesired small diameter trees and brush from the dry forest area and removing said undesired trees and brush from its native forest; and
feeding said undesired trees and brush and burning them in the boiler means to convert the undesired trees and brush to live steam.
